(19) United States
(12) Patent Application Publication
(10) Pub. No.: US 2011/0162543 A1
(43) Pub. Date: Jul. 7, 2011

(54) INKING METHOD AND APPARATUS THEREOF

(76) Inventors: Shuntaro Suzuki, Yokohama-shi (JP); Guilherme Jorge Maeda, Sydney (AU)

(21) Appl. No.: 13/061,585

(22) PCT Filed: Jun. 3, 2010
(86) PCT No.: PCT/JP2010/003708

§ 371 Date: Mar. 1, 2011

(30) Foreign Application Priority Data
Jun. 5, 2009 (JP) 2009-136244

(51) Int. Cl. B41F 9/10

(52) U.S. Cl. 101/169

(57) ABSTRACT

An ink return blade 17, an ink filling blade 18, and an ink removal blade 19 are disposed in order at a retreat height that is higher by a predetermined dimension than the plate 10 retained in the plate table 11, and are supported by a supporting frame 20 at a predetermined position on a pedestal 8 of an offset printing apparatus. Separate elevating/lowering actuators 21, 22, 23 are provided for each blade 17, 18, 19. When the plate table 11 that retains the plate 10 is driven in one direction, after ink from an ink pool 25 on the plate 10 is filled into the plate 10 by the ink filling blade 18, and excess ink is removed by the ink removal blade 19. Therefore the plate 10 with a suitable amount of inking thereon can be supplied for printing operations. Thereafter, when the plate table 11 is driven in the opposite direction, the ink return blade 17 is brought into contact with the plate 10, and the ink pool 25 is returned to an initial position.

### TECHNICAL FIELD

The present invention relates to an inking method and an apparatus thereof, and more particularly, relates to an inking method and an apparatus thereof enabling more efficient inking of a flat plate.

This application claims the benefit of Japanese Patent Application 2009-136244 filed in Japan on Jun. 5, 2009, the entire disclosure of which is incorporated by reference herein.

### BACKGROUND ART

In recent years, a method of forming an electrode pattern (conductive pattern) of a liquid crystal display or the like on a desired substrate includes a printing technique of using conductive paste as a printing ink in substitution for fine processing by etching or the like of a vapor-deposited metallic film. For example, a method has been proposed in which an intaglio offset printing technique is used to print and form an electrode pattern on a substrate. (For example, refer to Patent Document 1 and Patent Document 2).

When the electrode pattern of a liquid crystal display or the like is formed on substrate, a fine electrode width, for example, of the level of 10 μm may be required. Furthermore, a plurality of electrode patterns may be formed and superimposed on the substrate. When a plurality of electrode patterns are formed and superimposed on the substrate, overprinting of the electrode pattern may be performed by changing a plate. In this case, the electrode pattern does not retain its shape when there is a deviation in the printing position. Therefore, although there are slight variations in accuracy depending upon the printed object, it may be necessary to suppress overlay shift to the order of several μm in a fine electrode pattern having an electrode width of the order of 10 μm. Consequently, printing of an electrode pattern on the substrate requires a high printing accuracy in comparison to normal intaglio offset printing which prints characters and images on paper or the like.

When printing on paper, a roll plate (cylindrical intaglio) is often used as the intaglio. When this type of roll plate is used, generally, as shown in FIG. 9, the roll plate 1 is rotated by bringing a blade 2 into contact with one position in a peripheral direction on an outer peripheral face of the roll plate 1. In this manner, ink, which accumulates in an ink pool 3 provided on a surface portion that faces an upstream side in the roll rotation direction of the blade 2 that makes contact with the outer peripheral surface of the roll plate 1, is filled into the indented portion of the roll plate 1 by the blade 2 and unnecessary ink (excess ink) is removed from the surface of the roll plate 1 by the blade 2 to thereby perform inking of the roll plate 1.

When the roll plate 1 moves through a single rotation in this type of inking method, the commencement of the next inking process becomes possible when the inking is completed. An amount of ink filled into the indented portion of the roll plate 1 is small, thereby replenishment of the ink to the ink pool 3 is often not required even when continuously printing a job of several hundred sheets.

When the printing pattern is printed by transfer and retransfer using offset printing, reproduction characteristics are higher when the plate and the printing object have the same shape. As a result, when printing a precise printing pattern such as an electrode pattern on a substrate as described above, use of a flat plate is advantageous.

Regarding a manufacturing of a color filter substrate applying an intaglio printing method as described above, as one of an inking method in order to increase an accuracy of inking filling into the indented portion of the flat plate, a conventional inking method has been proposed in substitution for a method that fills ink onto the plate with a single blade and removes unnecessary (excess) ink, as shown in FIG. 10. This method includes a designated ink filling blade 4 for filling ink and a designated ink removal blade 5 for removing unnecessary (excess) ink. The method is configured so that the ink filling blade 4 and the ink removal blade 5 are retained at a fixed interval and are displaced integrally in the same direction on a flat plate 6 to thereby fill ink 7 onto the plate 6 and, at the same time, remove unnecessary ink on the plate 6. Alternatively, in substitution for the ink filling blade 4, use of an ink (inking) filling roller (not shown) has also been proposed (for example, refer to Patent Document 3).

### [Citation List]

### [Patent Document]

[Patent Document 1] Japanese Patent No. 2797567

[Patent Document 2] Japanese Patent No. 3904433

[Patent Document 3] Japanese Patent Application, First Publication. 2008-64996

### DISCLOSURE OF THE INVENTION

### Problem to be Solved by the Invention

In the inking method shown in FIG. 10, when commencing inking, ink 7 for filling the indented portion of the plate 6 must be pre-charged using the ink filling blade 4 into one end edge portion of the plate 6 that forms the upstream end edge portion in the direction of displacement of the ink removal blade 5 and the ink filling blade 4. Thus ink 7 must be supplied to one end edge portion of the plate 6 each time that inking is performed on the plate 6. Alternatively, after completing inking, a regular ink-removal operation is necessary since an ink pool is produced on the other end edge portion that forms the downstream end edge portion in the displacement direction of each blade 4, 5 on the plate 6.

When an accurate printing pattern such as an electrode pattern is printed, since high accuracy is required, the size of the plate should be as small as possible. In addition, in view of the cost of manufacturing the plate, it is preferred that the plate size should be as small as possible. However in the inking method as shown in FIG. 10, the effective scope of inking is the range in which both the ink filling blade 4 and the ink removal blade 5 displace on the plate 6. For this reason, both end edge portions upstream and downstream in the direction of displacement of the blades 4, 5 on the plate 6 must be provided with a space adapted to the dimensions of the interval provided between the ink filling blade 4 and the ink removal blade 5 on an outer side of the effective range of the plate 6 forming the printing pattern. As a result, the problem arises that the size of the plate 6 increases.

Moreover, in general, a printing pattern such as an electrode pattern often includes lines arrayed along two orthogonal directions. As a result, there is a risk that partial filling loss or residue after removal may result due to wear only on a part of the blade after repeated inking on a plate including a printing pattern provided with many lines extending along the displacement direction relative to the plate and the blade used for ink filling and removal during inking of the plate.

The present invention provides an inking method and an apparatus thereof as described below. In other words, when performing inking on a flat plate, there is no requirement to provide ink on every occasion that inking is performed. Furthermore, regular removal operations for an ink pool can be omitted. In addition, the size of the plate can be reduced. In this manner, by reducing the possibility that wear is only caused on a part of the blade, the possibility of partial filling loss or residue after removal can be reduced.

### Means for Solving the Problem

According to a first aspect of the present invention, the inking method according to the present invention includes a step of filling ink from an ink pool disposed on an upper side of one end edge portion of the plate into a plate while displacing the ink to another end edge portion of the plate using an ink filling blade that slides from one end edge portion to the another end edge portion of the plate, a step of removing an excess portion of the ink, that is filled into the plate, with an ink removal blade that slides from the one end edge portion to the another end edge portion of the plate, and displacing the ink to the another end edge portion of the plate, and a step of displacing the ink in the ink pool formed on an upper side of the another end edge portion of the plate after supply for printing, the ink being displaced to the one end edge portion by an ink return blade that slides from the another end edge portion to the one end edge portion of the plate.

According to a second aspect of the present invention, when the plate table that retains the plate and that moves below each blade moves in one direction, the inking method according to the present invention includes a step of bringing the ink filling blade and the ink removal blade respectively into contact with the plate at the point in time when a predetermined position of one end edge portion of the plate retained on a plate table is immediately below, a step of respectively separating the ink filling blade and the ink removal blade from the plate at the point in time when the predetermined position of the another end edge portion of the plate is immediately below, and when the plate table moves in the opposite direction, a step of bringing the ink return blade into contact at the point of time when another predetermined position of the another end edge portion of the plate retained on the plate table is immediately below, and a step of respectively separating the ink returning blade from the plate at the point of time when the another predetermined position of the another end edge portion of the plate retained on the plate table is immediately below.

According to a third aspect of the present invention, the inking method according to the present invention slides each blade against the plate in a configuration in which each blade is disposed at an inclination relative to the direction of sliding relative to the plate.

According to a fourth aspect of the present invention, the inking method according to the present invention displaces each blade reciprocally in a transverse direction when each blade slides on the plate.

According to a fifth aspect of the present invention, an inking apparatus according to the present invention includes an ink filling blade that slides from one end edge portion to another end edge portion of the plate and fills ink into the plate from an ink pool displaced on an upper side of the one end edge portion of the plate, an ink removal blade that slides from the one end edge portion to the another end edge portion of the plate and removes an excess amount of ink that has been filled into the plate by the ink filling blade, an ink return blade that slides from the another end edge portion to the one end edge portion of the plate and returns the ink pool to the one end edge portion of the plate, the ink pool being displaced to the another end edge portion of the plate by each blade, and an elevating/lowering actuator respectively mounted on the ink filling blade, the ink removal blade and the ink return blade. The respective ink filling blade, the ink removal blade and the ink return blade are elevated and lowered independently by individual elevating/lowering actuators from a position in contact with the plate to a position separated from the plate by a desired interval.

According to a sixth aspect of the present invention, an inking apparatus according to the present invention further includes a controller that synchronously controls the elevating/lowering of each blade by each elevating/lowering actuator and the displacement of the plate table that retains the plate and moves below each blade.

According to a seventh aspect of the present invention, an inking apparatus according to the present invention configures the planar disposition of each blade to incline relative to the direction of sliding of each blade relative to the plate.

According to an eighth aspect of the present invention, an inking apparatus according to the present invention slides each blade on the plate while executing reciprocating motion in a transverse direction.

### EFFECTS OF THE INVENTION

According to the present invention, the superior effects as described hereafter are obtained.

(1) The inking method and the inking apparatus according to the present invention have the following configuration.

Inking method: Ink from the ink pool disposed on an upper side of one end edge portion of the plate is filled into the plate while displacing the ink to the other end edge portion of the plate with the ink filling blade that slides from one end edge portion to the other end edge portion of the plate. Then an excess amount of the ink that is filled into the plate is removed by the ink removal blade that slides from one end edge portion to the other end edge portion of the plate and displaced to the other end edge portion of the plate. In this manner, inking onto the plate is performed. Furthermore, ink in the ink pool that is formed on an upper side of the other end edge portion of the plate after supply for printing is displaced to one end edge portion of the plate by the ink return blade that slides from the other end edge portion to one end edge portion of the plate, and then supplied to a subsequent inking operation.

Inking Apparatus: the apparatus includes an ink filling blade that slides from one end edge portion to the other end edge portion of the plate and fills ink into the plate from an ink pool disposed on an upper side of one end edge portion of a plate, an ink removal blade that slides from one end edge portion to the other end edge portion of the plate and removes an excess amount of ink that has been filled into the plate by the ink filling blade, an ink return blade that slides from one end edge portion to the other end edge portion of the plate and returns the ink pool to one end edge portion of the plate, the ink pool being displaced to the other end edge portion of the plate by each blade, and individual elevating/lowering actuators respectively mounted on the ink filling blade, the ink removal blade and the ink return blade. The respective ink filling blade, the ink removal blade and the ink return blade are elevated and lowered by individual elevating/lowering actuators from a position in contact with the plate to a position separated from the plate by a desired interval.

Thus the inking method and the inking apparatus according to the present invention enables effective inking of a suitable amount of ink with respect to a printing pattern that is formed on a plate.

(2) The inking method and the inking apparatus according to the present invention do not depend on the interval of disposition between each blade but rather enable the position at which the ink filling blade and the ink removal blade separate from the plate to be placed in proximity to the position at which the ink return blade comes into contact with the plate. Furthermore the position at which the ink return blade separates from the plate can be placed in proximity to the position at which ink filling blade and the ink removal blade are placed in contact with the plate. Thus, a blank space disposed on an outer portion of the region provided with the printing pattern for forming the ink pool on the plate can be reduced, and therefore the size of the plate can be reduced.

(3) The inking method and the inking apparatus according to the present invention do not require supply of ink each occasion that inking on the plate is performed. Furthermore ink from the ink pool is continuously available for inking. In this manner, a regular operation for removal of the ink pool is not required.

(4) The inking method and the inking apparatus according to the present invention have the following configuration.

Inking Method: when a plate table that retains the plate and moves below each blade moves in one direction, the ink filling blade and the ink removal blade are respectively brought into contact with the plate at the point in time when a predetermined position of one end edge portion of the plate retained on the plate table is immediately below. Together with this process, the blades are separated from the plate at the point in time when a predetermined position of the other end edge portion of the plate is immediately below. When the plate table moves in the opposite direction, the ink return blade is brought into contact with the plate at the point in time when another predetermined position of the other end edge portion of the plate retained on the plate table is immediately below. The ink returning blade is separated from the plate at the point in time when the another predetermined position of the other end edge portion of the plate retained on the plate table is immediately below.

Inking apparatus: a controller is provided that synchronously controls the elevating/lowering of each blade by each elevating/lowering actuator and the displacement of the plate table that retains the plate and moves below each blade.

In this manner, inking onto the plate and an operation of returning the ink pool on the plate to an original position can be performed by the reciprocating motion of the plate table that retains the plate. Thus smooth continuous printing can be performed.

(5) The inking method and the inking apparatus according to the present invention enables sliding with the plate in a configuration in which each blade is disposed at an inclination relative to the direction of sliding relative to the plate. A printing pattern such as an electrode pattern often arrays lines along two mutually orthogonal directions. However the inking method and the inking apparatus according to the present invention enable each blade to be oriented at an inclination with respect to the lines of this type of printing pattern. As a result, the possibility of the lower end portion of each blade mounting the line provided on the printing pattern of the plate is reduced, and thereby the possibility of damage to the printing pattern of the plate or to each blade can be reduced.

(6) The inking method and the inking apparatus according to the present invention displace each blade reciprocally in a transverse direction when each blade slides on the plate, and thereby reduce the possibility of partial wear to each blade. As a result, the time until the blades are exchanged can be increased.

### BRIEF DESCRIPTION OF THE DRAWINGS

FIG. 1 is a sectional side view showing a first embodiment of an inking apparatus according to the present invention using the inking method according to the present invention.

FIG. 2 is a schematic side view showing the overall structure of an offset printing apparatus applying the inking apparatus shown in FIG. 1.

FIG. 3 is a schematic view showing the control configuration of a controller provided in the inking apparatus shown in FIG. 1.

FIG. 4A is a schematic side view showing the order of implementation of the inking method according to the present invention using the inking apparatus shown in FIG. 1, and shows a state in which the ink filling blade is placed in contact with a predetermined position on the plate.

FIG. 4B is a schematic side view showing the order of implementation of the inking method according to the present invention using the inking apparatus shown in FIG. 1, and shows a state in which the ink removal blade is placed in contact with a predetermined position on the plate.

FIG. 5A is a schematic side view showing the order continuing on from FIG. 4B of implementation of the inking method according to the present invention using the inking apparatus shown in FIG. 1, and shows a state in which the ink filling blade is separated from a predetermined position on the plate.

FIG. 5B is a schematic side view showing the order continuing on from FIG. 4B of implementation of the inking method according to the present invention using the inking apparatus shown in FIG. 1, and shows a state in which the ink removal blade is separated from a predetermined position on the plate.

FIG. 6 is a schematic side view showing the order continuing on from FIG. 5B of implementation of the inking method according to the present invention using the inking apparatus shown in FIG. 1, and shows a state in which the ink return blade is placed in contact with a predetermined position on the plate.

FIG. 7 is a schematic side view showing the order continuing on from FIG. 6 of implementation of the inking method according to the present invention using the inking apparatus shown in FIG. 1, and shows a state in which the ink return blade is separated from a predetermined position on the plate.

FIG. 8 is a schematic plan view showing the principal components of another embodiment of the present invention.

FIG. 9 shows the schematic configuration of an example of an inking method using a blade in relation to a roll plate.

FIG. 10 shows a schematic configuration of an inking method in a conventional example that increases the accuracy of the inking in relation to a flat plate.

### BEST MODES FOR CARRYING OUT THE INVENTION

An embodiment implementing the present invention will be described making reference to the figures.

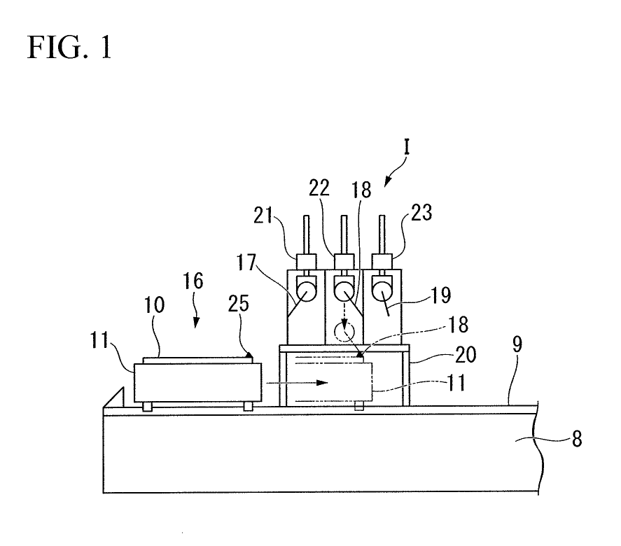

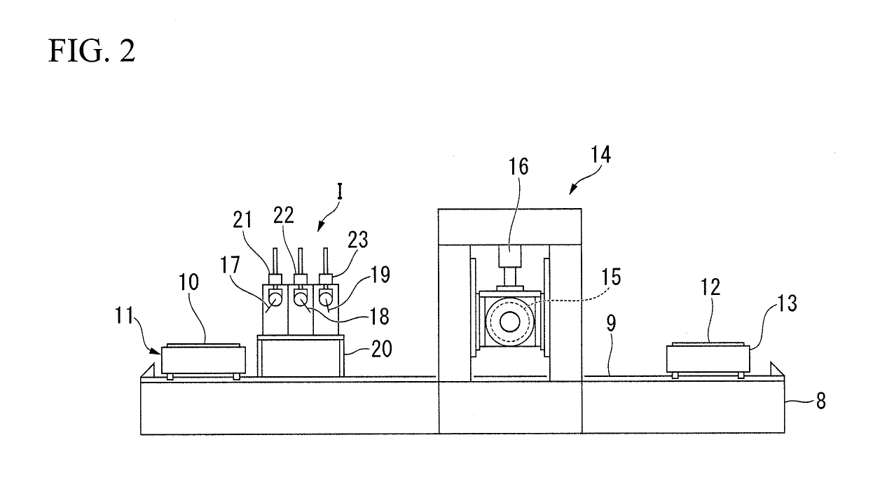

FIG. 1 to FIG. 7 show an embodiment of the inking method and apparatus according to the present invention, and for example, show an example that is applied to an offset printing apparatus having the configuration as shown in FIG. 2.

The offset printing apparatus shown in FIG. 2 will be described. The offset printing apparatus shown in FIG. 2 includes a pedestal 8, a guide rail 9 provided on the pedestal 8, a plate table 11 retaining the plate 10 to enable independent reciprocating motion (movement) along the guide rail 9, a substrate table 13 retaining a substrate 12 that is the printing object, and a transfer mechanism 14 includes a blanket roll 15 that can be elevated and lowered by an elevating/lowering actuator 16. The offset printing apparatus brings the blanket roll 15 of the transfer mechanism 14 into contact from above with the plate 10 that is retained on the plate table 11 that moves on the guide rail 9. Then, transfer operations from the plate 10 to the blanket roll 15 and retransfer operations from the blanket roll 15 onto the substrate 12 that is the printing object can be implemented by bringing the blanket roll 15 in contact from above with the substrate 12 that is retained on the substrate table 13 that moves on the guide rail 9.

Reference numeral I in FIG. 1 and FIG. 2 denotes an inking apparatus according to the present invention used in the implementation of the inking method according to the present invention applied to an offset printing apparatus having the above configuration. The inking apparatus I is installed using a supporting frame 20 in a configuration in which the ink return blade 17, the ink filling blade 18 and the ink removal blade 19 are arranged in order from one longitudinal end of the guide rail 9 at a retreat height that forms a higher predetermined dimension than the height of displacement of the plate that is retained on the plate table 11 that displaces along the guide rail 9. The blades 17, 18, 19 are disposed on a predetermined position in a range in which the plate table 11 moves on the pedestal 8 in the offset printing apparatus, for example on a position that is separated by a predetermined interval more towards one longitudinal end of the guide rail 9 than the transfer mechanism 14.

Separate elevating/lowering actuators 21, 22, 23 are respectively mounted on each blade 17, 18, 19. The elevating/lowering actuators 21, 22, 23 are driven to separately lower the corresponding blades 17, 18, 19 from the retreat height position to a height position at which the lower end portion of each blade 17, 18, 19 comes into contact with the plate 10 that is retained on the plate table 11.

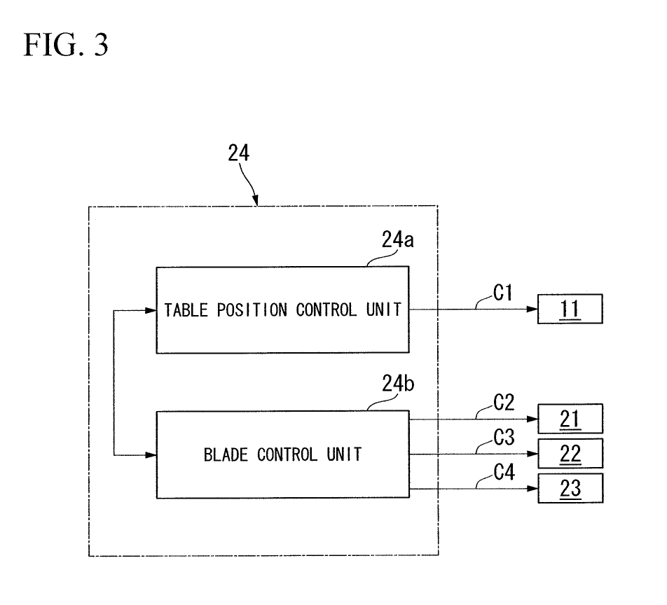

Furthermore as shown in FIG. 3, the inking apparatus I includes a table position control unit 24a that applies a table position control command C1 to the plate table 11, a blade control unit 24b that applies separate blade operating commands C2, C3, C4 to the respective elevating/lowering actuators 21, 22, 23 for each blade 17, 18, 19 based on a detection signal for the position in relation to the longitudinal direction of the guide rail 9 of the plate table 11 inputted from a position detection mechanism of the plate table 11 such as a linear scale or the like (not shown) provided on the pedestal 8, and a controller (control apparatus) 24 that is adapted to enable synchronous control of the table position control unit 24a and the blade control unit 24b.

More specifically, the ink return blade 17 is inclined so that the lower end side is positioned more towards one longitudinal end of the guide rail 9 than the upper end.

The ink filling blade 18 and the ink removal blade 19 are inclined so that the lower end side rather than the upper end side is positioned more towards the longitudinal other end portion of the guide rail 9. Furthermore the ink filling blade 18 is set so that the angle of inclination from the horizontal plate is smaller than the ink removal blade 19. In this manner, even when ink that has a high viscosity such as a conductive paste is used as an ink, the filling efficiency of the ink on the plate 10 can be improved by using the ink filling blade 18 with a smaller inclination angle from the horizontal plane. After forcibly pressing into the indented portion of the plate 10 with the ink filling blade 18, the excess amount (unnecessary portion) of ink that protrudes from the plate 10 after the passage of the ink filling blade 18 can be removed with the ink removal blade 19 that has enhanced removal performance due to increasing the inclination angle from the horizontal plane. In this manner, a suitable amount of ink is inked into the indented portion of the plate 10.

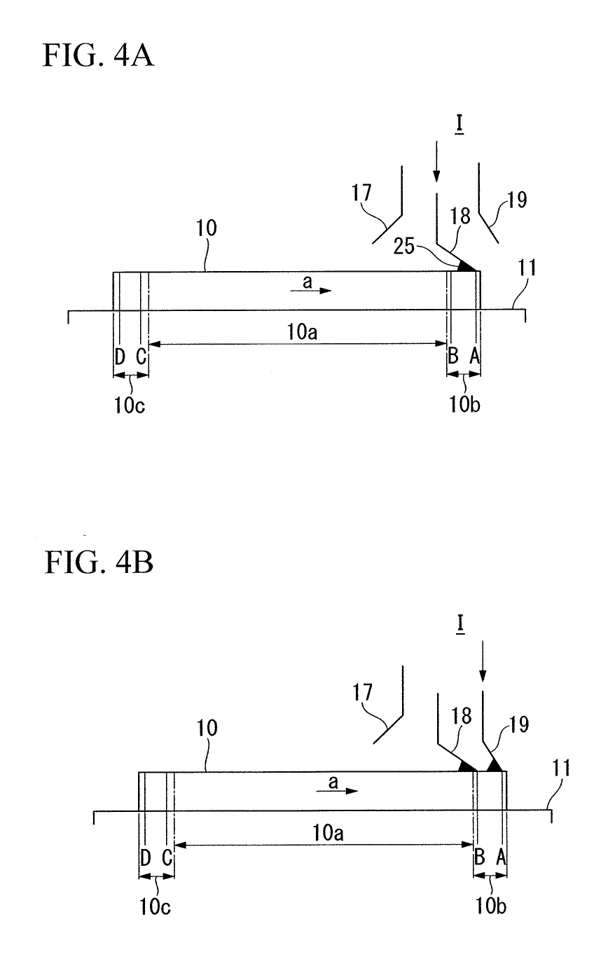

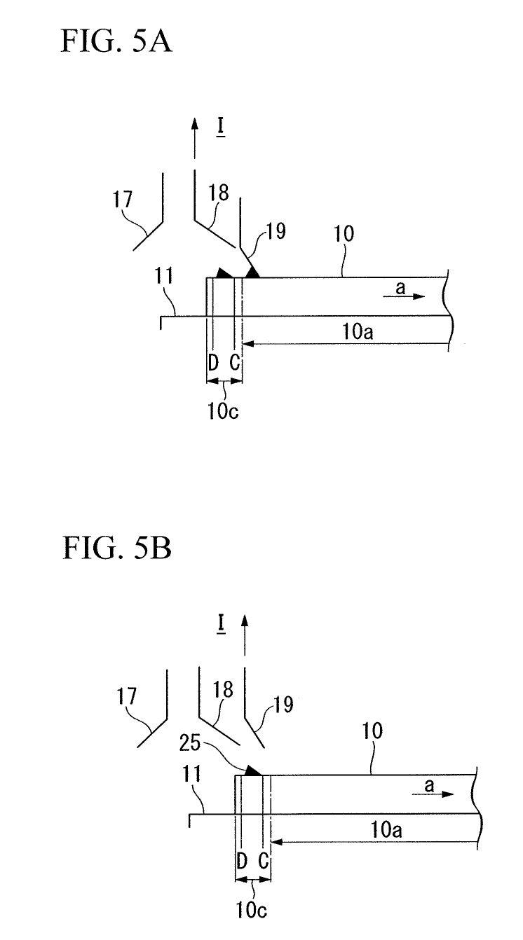

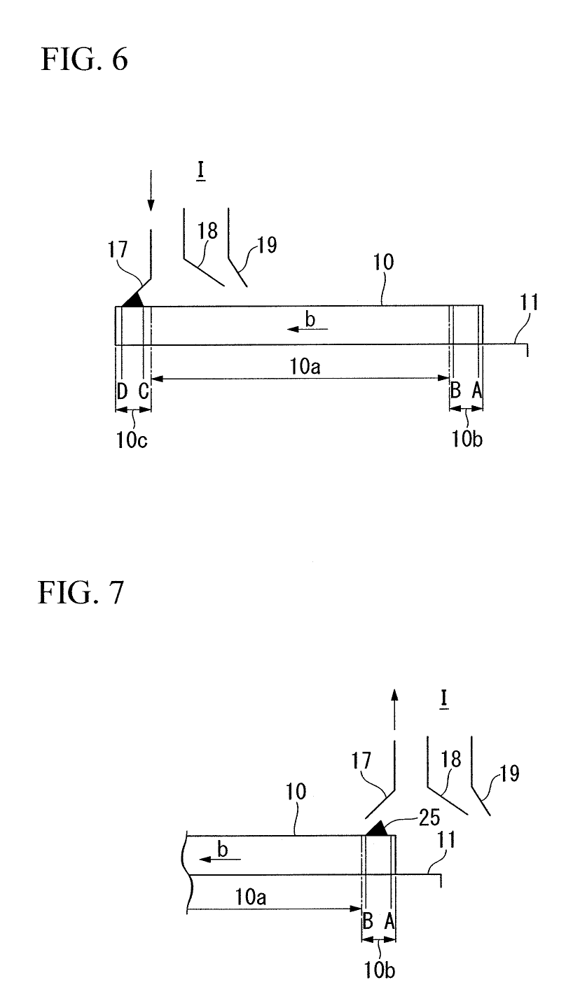

The sequence of the inking method according to the present invention that is implemented using the inking apparatus according to the present invention will be described making reference to FIG. 4A, FIG. 4B to FIG. 7 based on the details of the control performed by the controller 24. To implement inking on the plate 10 using the ink filling blade 18 and the ink removal blade 19, when the plate table 11 that retains the plate 10 that is the object of inking is displaced from one longitudinal end portion of the guide rail 9 as shown by the arrow a in FIG. 4A, FIG. 4B, FIG. 5A, FIG. 5B towards the transfer mechanism 14 through the installation position of the inking apparatus I according to the present invention, the direction of displacement of the plate 10 on the plate table 11 is taken to be the inking displacement direction. Conversely as shown by the arrow b in FIG. 6 and FIG. 7, when the plate table 11 that retains the plate 10 is displaced away from the transfer mechanism 14 towards one longitudinal end portion of the guide rail 9 through the installation position of the inking apparatus I according to the present invention, the displacement direction of the plate 10 on the plate table 11 is taken to be the plate return displacement direction.

In relation to the plate 10 retained on the plate table 11, as shown in FIG. 4A, the controller 24 can detect (define) the alignment of the plate 10 retained on the plate table 11 and the alignment of the effective range 10a of the plate 10 provided with the indented portion of the printing pattern on the plate 10 based on pre-inputted information related to the dimensions or the like of the surface shape of the plate 10 or the plate table 11 using the positional information of the plate table 11. The controller 24 enables detection (definition) of a blank portion on which the printing pattern is not provided on an outer side of the effective range 10a on the plate 10. In other words, a position slightly more towards the inner side than the end portion of the plate 10 (hereafter position A) and a position slightly more towards an outer side than the effective range 10a of the plate 10 (hereafter position B) are provided on the blank portion 10b that is positioned more forward in the inking displacement direction than the effective range 10a along the inking displacement direction with respect to the blank portion in which the printing pattern is not provided on an outer side of the effective range 10a in the plate 10. A position slightly more towards the outer side than the effective portion 10a of the plate 10 (hereafter position C) and a position slightly more towards an inner side than the end portion of the plate 10 (hereafter position D) are provided on the blank portion 10c that is positioned more rearward in the inking displacement direction than the effective range 10a of the plate 10 along the inking displacement direction. The controller 24 enables detection (definition) of each position A, B, C, D based on the positional information of the plate table 11.

Prior to implementing inking using the inking apparatus I according to the present invention, the plate table 11 retaining the plate 10 that is the object of inking is disposed in advance at an inking start position (not shown) that is set more towards one longitudinal end of the guide rail 9 (refer to FIG. 1) than the set position of each blade 17, 18, 19. Furthermore as shown in FIG. 4A, a predetermined amount of ink is supplied by the ink supply mechanism (not shown) between position A and position B of the blank portion 10b that is positioned more towards the front of the inking displacement direction than the effective range 10a in the plate 10, to thereby form the ink pool 25 along the whole transverse length.

In this configuration, the controller 24 starts displacement at a predetermined velocity in the inking displacement direction from the inking start position (not shown) on the plate table 11 retaining the plate 10 by using the function of the table position control unit 24a.

Thereafter, as shown in FIG. 4A, when the position A of the plate 10 that is detected based on positional information for the plate table 11 that is displaced in the inking displacement direction reaches a position corresponding to the lower end of the ink filling blade 18, the controller 24 gives a command to the elevating/lowering actuator 22 (refer to FIG. 1) of the ink filling blade 18 to thereby lower the ink filling blade 18 by driving the elevating/lowering actuator 22 to a position in contact with the plate 10 on the plate table 11. In this manner, the ink filling blade 18 that is in contact with the plate 10 undergoes relative sliding along the surface of the plate 10 that displaces in the inking displacement direction together with the plate table 11. In this manner, ink in the ink pool 25 that is preformed on the blank portion 10b that is positioned more forward in the inking displacement direction than the effective range 10a of the plate 10 is removed along the surface of the plate 10 that is displaced in the inking displacement direction together with the plate table 11 by the ink filling blade 18 that is in contact with the plate 10, and thereby the ink starts to fill the indented portion of the plate 10.

Next, as shown in FIG. 4B, when the position A of the plate 10 that is detected based on positional information for the plate table 11 displaced in the inking displacement direction reaches a position corresponding to the lower end of the ink removal blade 19, the controller 24 gives a command to the elevating/lowering actuator 23 (refer to FIG. 1) of the ink removal blade 19 to thereby drive the elevating/lowering actuator 23 and lower the ink removal blade 19 to a position in contact with the plate 10 on the plate table 11. In this manner, the ink removal blade 19 that is in contact with the plate 10 undergoes relative sliding along the surface of the plate 10 that displaces in the inking displacement direction together with the plate table 11. In this manner, the excess amount of ink filled into the indented portion of the plate 10 by the ink filling blade 18 can be removed by the ink removal blade 19. Thus inking using a suitable amount of ink can be performed with respect to the indented portion of the plate 10 at positions at which the contact portion with the ink removal blade 19 has passed on the plate 10.

Next, the controller 24 implements control to continuously perform filling of ink onto the plate 10 using the ink filling blade 18 and removal of an excess amount of ink by the ink removal blade 19 in the interval during which the position C of the plate 10 that is detected based on the positional information for the plate table 11 that displaces in the inking displacement direction reaches a position that corresponds with the lower end portion of the ink filling blade 18.

Thereafter, as shown in FIG. 5A, when the position C of the plate 10 that is displaced in the inking displacement direction together with the plate table 11 reaches a position corresponding to the lower end of the ink filling blade 18, the controller 24 gives a command to the elevating/lowering actuator 22 (refer to FIG. 1) of the ink filling blade 18 to thereby raise the ink filling blade 18 to a retreat position. Next, as shown in FIG. 5B, when the position C of the plate 10 reaches a position corresponding to the lower end of the ink removal blade 19, the controller 24 gives a command to the elevating/lowering actuator 23 (refer to FIG. 1) of the ink removal blade 19 to thereby raise the ink removal blade 19 to a retreat position. In this manner, a suitable amount of ink can be subjected to inking in the indented portion along the whole face in the effective range 10a that is formed by the printing pattern of the plate 10 by enabling sequential relative sliding of the ink filling blade 18 and the ink removal blade 19 in the region from the position A to the position C on the plate 10. The excess amount of ink that was not filled into the indented portion of the plate 10 is collected by the ink filling blade 18 and the ink removal blade 19. Consequently, an ink pool 25 is formed between the position C and the position D in the blank portion 10c that is positioned in the inking displacement direction immediately behind the position C of the plate 10 at which the blades 18, 19 separate from the plate 10, that is to say, more rearward in the inking displacement direction than the effective range 10a on the plate 10.

When implementing inking on the plate 10 using the inking apparatus I according to the present invention as described above, the controller 24 forwards the plate table 11 that retains the inked plate 10 to the transfer mechanism 14 (refer to FIG. 2) and supplies the inked plate 10 for offset printing.

After supplying the inked plate 10 for offset printing on the transfer mechanism 14, the controller 24 moves the plate table 11 in the plate return displacement direction as shown in FIG. 6. At this time, when the position D of the plate 10 that is detected based on positional information for the plate table 11 that displaces in the plate return displacement direction reaches a position corresponding to the lower end of the ink return blade 17, the controller 24 gives a command to the elevating/lowering actuator 21 (refer to FIG. 1) of the ink return blade 17 to thereby lower the ink return blade 17 by driving of the elevating/lowering actuator 21 to a position making contact with the plate on the plate table 11. In this manner, the ink return blade 17 that is in contact with the plate 10 undergoes relative sliding along the surface of the plate 10 that displaces in the inking displacement direction together with the plate table 11. In this manner, ink in the ink pool 25 that is formed on the blank portion 10c that is positioned more in a rearward direction in the inking displacement direction than the effective range 10a of the plate 10 is removed by the ink return blade 17 that makes contact with the plate 10, and is displaced to a forward side of the inking displacement direction of the plate 10.

Next, as shown in FIG. 7, when the position B of the plate 10 that is detected based on positional information for the plate table 11 displaced in the inking plate return displacement direction reaches a position corresponding to the lower end of the ink return blade 17, the controller 24 gives a command to the elevating/lowering actuator 21 (refer to FIG. 1) of the ink return blade 17 to thereby raise the ink return blade 17 with the elevating/lowering actuator 21 to a retreat position. In this manner, the ink return blade 17 that is in contact with the plate 10 becomes separated from the plate 10 at the position B of the plate 10. In this manner, the ink pool 25 is returned to an initial position between the position A and the position B of the blank portion 10b that is a positioned immediately forward of the inking displacement direction than the position B of the plate 10, that is to say, more forward of the inking displacement direction than the effective range 10a on the plate 10.

In this manner, thereafter, inking can be performed on the plate 10 on a subsequent occasion and the inked plate 10 can be supplied for offset printing by implementing the operations shown in FIG. 4A, FIG. 4B, FIG. 5A and FIG. 5B. The plate 10 after supply for offset printing passes through the inking apparatus I according to the present invention in the sequence shown in FIG. 6 and FIG. 7, and the position of the ink pool 25 on the plate 10 is returned to an initial position.

As described above, an inking method and apparatus according to the present invention enable efficient filling of the indented portion of the plate 10 by the ink filling blade 18 and efficient removal of the excess portion of ink by the ink removal blade 19 with respect to the effective range formed by the printing pattern on the plate 10. In this manner, the inking of a suitable amount of ink can be efficiently implemented in relation to the plate 10.

Moreover, the reciprocating motion of the plate table 11 that retains the plate 10 enables inking of the plate 10 and the operation of returning the ink pool on the plate 10 to an initial position. As a result, there is no need to supply ink each occasion that inking of the plate 10 is performed. Furthermore, ink from the ink pool is continuously available for inking. In this manner, a regular removal operation of the ink pool is not required.

Furthermore, after the plate table 11 is displaced once from the transfer mechanism 14 up to one longitudinal end of the guide rail, inking on the plate 10 can be performed by the reciprocating motion of returning again towards the transfer mechanism 14. As a result, smooth offset printing can be performed.

The ink filling blade 18, the ink removal blade 19 and the ink return blade 17 can be raised and lowered by separate elevating/lowering actuators 22, 23, and 21. As a result, after the ink filling blade 18 and the ink removal blade 19 are brought into contact with the position A of the plate 10, the blades become separated at the position C. After the ink return blade 17 is brought into contact at the position D of the plate 10, it then becomes separated at the position B. The contact position and the separation position of each blade 17, 18, 19 with the plate 10 can be freely set without dependence on the disposition interval between each blade 17, 18, 19. Thus the space for the blank portion 10b, 10c that is provided on an outer portion of the effective range 10a on the plate 10 in order to form the ink pool on the plate 10 can be reduced. In this manner, the size of the plate 10 can be reduced.

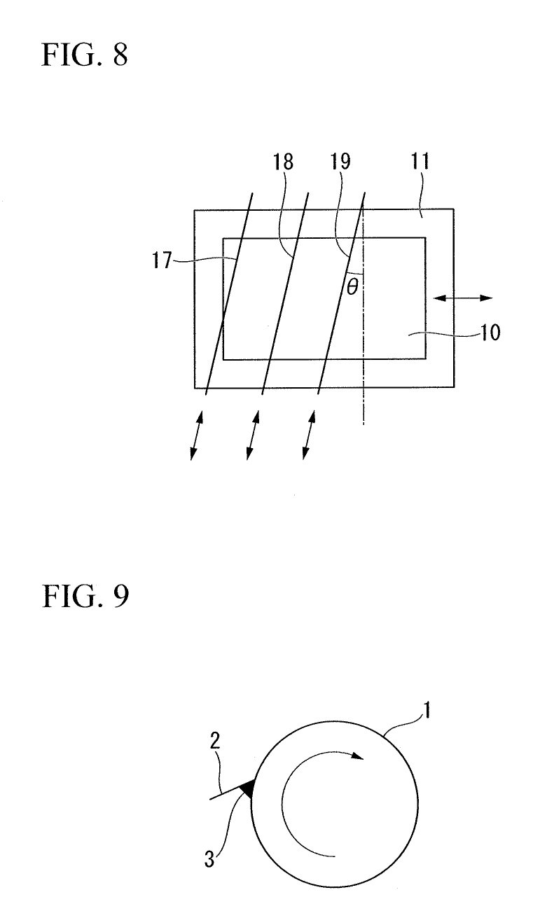

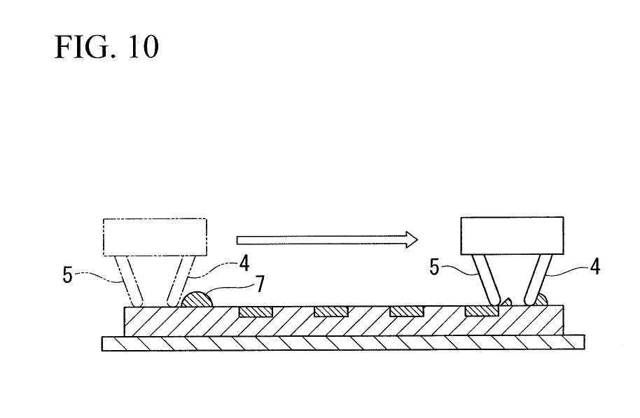

Another embodiment of the present invention is shown in FIG. 8. The embodiment shown in FIG. 8 is configured so that the planar disposition of the ink return blade 17, the ink filling blade 18 and the ink removal blade 19 is inclined by a predetermined angle θ from an orthogonal direction with respect to the displacement direction (reciprocating motion) of the plate table 11 that retains the plate 10.

In the present embodiment, each blade 17, 18, 19 can be subjected by a drive apparatus (not shown) to reciprocating motion (oscillation) in a longitudinal direction that is not synchronous to the motion of the plate 10 that moves together with the plate table 11.

This configuration is the same as that shown in FIG. 1 to FIG. 7, and similar components are denoted by the same reference numerals.

The printing pattern for an electrode pattern often includes lines arrayed along two orthogonal directions. According to the present embodiment, each blade 17, 18, 19 can be inclined with respect to the lines of the printing pattern. As a result, the possibility of the lower end portion of each blade 17, 18, 19 running on the line that is provided on the printing pattern of the plate can be reduced, and the possibility of wear to each blade 17, 18, 19 or damage to the printing pattern of the plate can be reduced.

The possibility of partial wear occurring on each blade 17, 18, 19 can be reduced by the reciprocating motion of each blade 17, 18, 19 in a longitudinal direction. As a result, the time until the blades are exchanged can be increased since wear in a longitudinal direction can be made uniform.

The present invention is not limited to the embodiments described above. The transverse dimensions or vertical dimensions of each blade 17, 18, 19 are merely shown for the purposes of illustration, and do not reflect the actual dimensions.

As long as each blade 17, 18, 19 can be elevated or lowered from a retreat position to a position in contact with the plate 10 that is retained on the plate table 11 in accordance with commands from the controller 24, an actuator having any configuration may be used as the elevating/lowering actuators 21, 22, 23 for each blade 17, 18, 19.

The angle of inclination θ of each blade 17, 18, 19 from an orthogonal angle toward the direction of displacement of the plate table 11 in the embodiment shown in FIG. 8 may be suitably modified to an angle other than the angle that is illustrated.

As long as a flat plate 10 is used, application is possible to any configuration of offset printing apparatus. Furthermore, application is also possible to any configuration of printing apparatus in addition to an offset printing apparatus.

Of course, various modifications may be added within a scope that does not depart from the spirit and scope of the present invention.

### INDUSTRIAL APPLICABILITY

According to the inking apparatus and method according to the present invention, there is no requirement to supply ink on each occasion that inking is implemented. Furthermore there is no requirement for a regular removal operation for the ink pool. It is possible to downsize the size of the plate. In addition, the risk of wear to only a portion of the blade can be reduced, and in that manner, it is possible to reduce the possibility of partial filling loss or removal residue. Furthermore, efficient inking can be performed on a flat plate.

### DESCRIPTION OF THE REFERENCE NUMERAL

10 PLATE
17 INK RETURN BLADE
18 INK FILLING BLADE
19 INK REMOVAL BLADE
21 ELEVATING/LOWERING ACTUATOR
22 ELEVATING/LOWERING ACTUATOR
23 ELEVATING/LOWERING ACTUATOR
24 CONTROLLER
25 INK POOL

1. An inking method comprising the steps of:
filling ink from an ink pool disposed on an upper side of one end edge portion of a plate into the plate while displacing the ink to another end edge portion of the plate using an ink filling blade that slides from the one end edge portion to the another end edge portion of the plate;
removing an excess portion of the ink, that is filled into the plate with an ink removal blade that slides from the one end edge portion to the another end edge portion of the plate, and displacing the ink to the another end edge portion of the plate; and
displacing the ink in the ink pool formed on an upper side of the another end edge portion of the plate after supply for printing, the ink being displaced to the one end edge portion by an ink return blade that slides from the another end edge portion to the one end edge portion of the plate.

2. The inking method according to claim 1, wherein the method further comprises the steps of:
when the plate table, that retains the plate and that moves below each blade, moves in one direction:
bringing the ink filling blade and the ink removal blade respectively into contact with the plate at the point in time when a predetermined position of one end edge portion of the plate retained on a plate table is immediately below;
separating the ink filling blade and the ink removal blade respectively from the plate at the point in time when the predetermined position of the another end edge portion of the plate is immediately below; and
when the plate table moves in the opposite direction:
bringing the ink return blade into contact at the point of time when another predetermined position of the another end edge portion of the plate retained on the plate table is immediately below; and
respectively separating the ink returning blade from the plate at the point of time when the another predetermined position of the another end edge portion of the plate retained on the plate table is immediately below.

3. The inking method according to claim 1 wherein each blade slides against the plate in a configuration in which each blade is disposed at an inclination relative to the direction of sliding relative to the plate.

4. The inking method according to claim 1 wherein each blade displaces reciprocally in a transverse direction when each blade slides on the plate.

5. The inking method according to claim 3 wherein each blade undergoes reciprocal motion in a transverse direction when each blade slides on the plate.

6. An inking apparatus comprising:
an ink filling blade that slides from one end edge portion to another end edge portion of the plate and fills ink into the plate from an ink pool displaced on an upper side of the one end edge portion of the plate;
an ink removal blade that slides from the one end edge portion to the another end edge portion of the plate and removes an excess amount of ink that has been filled into the plate by the ink filling blade;
an ink return blade that slides from the another end edge portion to the one end edge portion of the plate and returns the ink pool to the one end edge portion of the plate, the ink pool being displaced to the another end edge portion of the plate by each blade; and
an elevating/lowering actuator respectively mounted on the ink filling blade, the ink removal blade and the ink return blade; wherein:
the ink filling blade, the ink removal blade and the ink return blade are respectively elevated and lowered independently by individual elevating/lowering actuators from a position in contact with the plate to a position separated from the plate by a desired interval.

7. The inking apparatus according to claim 6 further comprising a controller that synchronously controls the elevating/lowering of each blade by each elevating/lowering actuator and the displacement of the plate table that retains the plate and moves below each blade.

8. The inking apparatus according to claim 6 or wherein the planar disposition of each blade inclines relative to the direction of sliding of each blade relative to the plate.

9. The inking apparatus according to claim 6 wherein each blade slides on the plate while implementing reciprocating motion in a transverse direction.

10. The inking apparatus according to claim 8 wherein each blade slides on the plate while implementing reciprocating motion in a transverse direction.
